(19) United States
(12) Patent Application Publication
(10) Pub. No.: US 2008/0036114 A1
(43) Pub. Date: Feb. 14, 2008

(54) MOLD HAVING SURFACE MODIFIED NON-MOLDING REGIONS

(75) Inventors: Akira Yoda, Tokyo (JP); Hiroshi Kikuchi, Yamato-Shi (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/834,077

(22) Filed: Aug. 6, 2007

Related U.S. Application Data
(60) Provisional application No. 60/822,272, filed on Aug. 14, 2006.

(51) Int. Cl. B29C 33/42

(52) U.S. Cl. 264/219; 264/293; 425/112

(57) ABSTRACT

Molds, methods of making molds, and methods of making microstructured (e.g. barrier ribs) articles from molds are described. The mold comprises a microstructured surface that comprises (e.g. groove) recesses defined by planar portions having a surface in the same plane and non-molding regions adjacent peripheral planar portions on at least two opposing sides. The non-molding regions comprise at least one surface modification that reduces the contact area of the non-molding regions with the substrate.

### RELATED APPLICATION DATA

This application claims the benefit of U.S. Provisional Application Ser. No. 60/822272, filed Aug. 14, 2006.

### BACKGROUND

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way barrier ribs can be formed on glass substrates is by direct molding. This has involved laminating a (e.g. flexible) mold onto a substrate with a glass- or ceramic-forming composition disposed there between. The glass or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

WO 2004/064104 describes a plasma display panel back plate comprising a (e.g. glass) substrate and barrier ribs. A non-rib region occupies at least a portion of the periphery of the barrier rib region that is made of the same material as the rib region. The described plasma display panel back plate can be prepared by molding a curable molding material with a (e.g. flexible) mold.

Although various molds suitable for use in the molding of barrier ribs have been described, industry would find advantage in new molds.

### SUMMARY OF THE INVENTION

In one embodiment, (e.g. flexible) molds are described. The molds are suitable for making microstructured articles such as barrier ribs on a substrate. The mold may be a single sheet or continuous roll having a microstructured molding surface that comprises grooves separated by planar portions having a surface in a common plane. The mold further comprises non-molding regions adjacent peripheral planar portions on at least two opposing sides. The non-molding regions comprise at least one surface modification that reduces the contact area of non-molding regions with a substrate during molding, thereby reducing adhesion of the mold with the substrate.

In one aspect, the surface of the non-molding regions may be physically modified. For example, the thickness of at least a portion of the non-molding regions may be reduced. In another aspect, the non-molding regions may comprise a roughened surface. In yet another aspect, the non-molding regions may include microstructures that are substantially smaller than the molding surface (e.g. barrier ribs) microstructures. Alternatively, the non-molding regions may be chemically modified.

In another embodiment, a method of making (e.g. barrier rib) microstructures is described. The method comprises providing the mold having surface modified non-molding regions on at least two opposing sides, providing a curable (e.g. rib precursor) material between the microstructured surface of the mold and a substrate, curing the curable material, and removing the mold thereby providing cured (e.g. barrier rib) microstructures on the substrate. The mold is typically removed in a direction substantially parallel to the physically modified non-molding regions. The cured (e.g. barrier ribs) microstructures have a positional error of less than 50 ppm (e.g. prior to sintering).

In other embodiments, methods of making a (e.g. flexible) microstructured mold are described. The mold may be prepared with known processes. The opposing peripheral non-molding regions may be surface modified after the mold has been made. Alternatively, a transfer mold and/or master mold, from which the (e.g. flexible) mold is subsequently formed, can include suitable physical modification(s).

### BRIEF DESCRIPTION OF THE DRAWINGS

FIG. 1 is a perspective view of an illustrative flexible mold suitable for making barrier ribs.

FIG. 2 is a roll of flexible molds having peripheral non-molding regions.

FIG. 3 is a cross-sectional view of a flexible mold taken along line 3-3 of the mold of FIG. 1.

FIG. 4 is a planar view showing the dimensions of the (e.g. barrier rib) microstructured molding region and non-molding region of an illustrative flexible mold.

### DETAILED DESCRIPTION OF THE PREFERRED EMBODIMENTS

Presently described are molds having a microstructured surface, methods of making microstructured articles by utilizing a mold, and methods of making molds. Hereinafter, the embodiments of the invention will be explained with reference to a flexible mold suitable for making microstructures such as barrier ribs. The flexible molds can be utilized to make other microstructured articles for (e.g. forming cells of) displays as well as other uses such as for example electrophoresis plates with capillary channels.

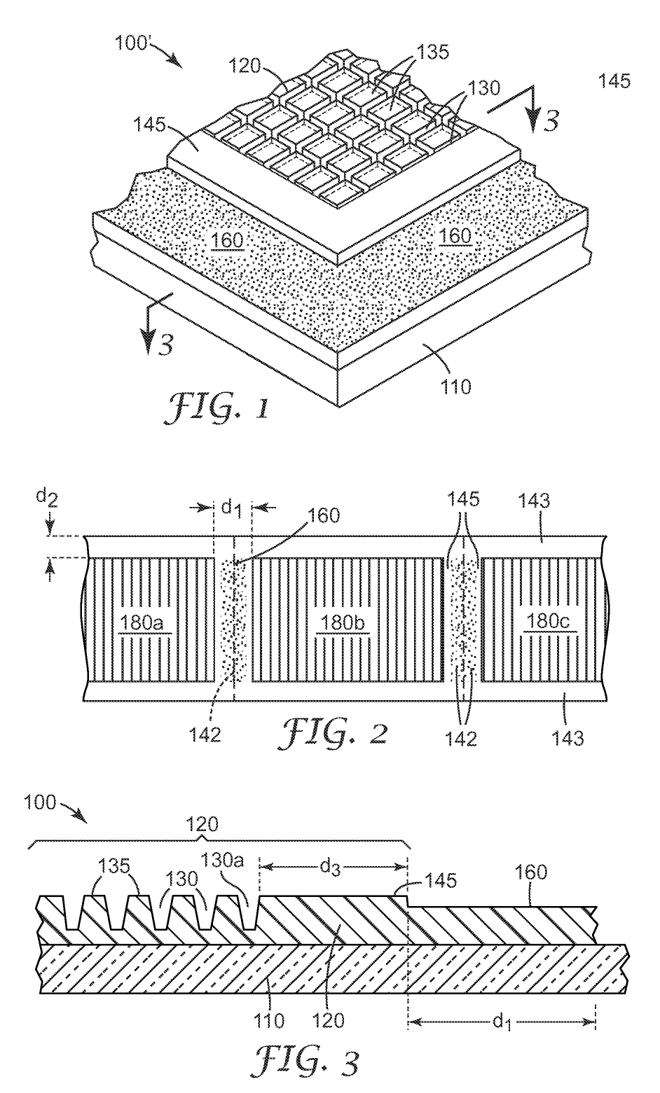

FIG. 1 is a partial perspective view showing an illustrative flexible mold 100. FIG. 3 is a cross-sectional view of the flexible mold of FIG. 1 taken along line 3-3. The flexible mold 100 generally has a two-layered structure having a planar support layer 110 and a microstructured molding surface, also referred to herein as a shape-imparting layer 120 provided on the support 110. The microstructured surface comprises a plurality of recesses, such as grooves 130. The grooves are separated by planar portions 135. The surfaces of such planar portions 135 are in the same plane.

The flexible mold 100 of FIG. 1 comprises a first set of parallel grooves intersecting with a second set of parallel grooves and is suitable for producing a grid-like rib pattern of barrier ribs on a (e.g. electrode patterned) back panel of a (e.g. plasma) display panel. Another common barrier rib pattern comprises a plurality of (non-intersecting) ribs arranged in parallel with each other, such as depicted in WO 2004/064104.

The depth, pitch and width of the microstructured grooves 130 of the shape-imparting layer can vary depending on the desired finished article. The depth of the microstructures (e.g. groove corresponding to the barrier rib height) is generally at least 100 μm and typically at least 150 μm. Further, the depth is typically no greater than 500 μm and typically less than 300 μm. The pitch of the microstructured (e.g. groove) pattern may be different in the longitudinal direction in comparison to the transverse direction. The pitch is generally at least 100 μm and typically at least 200 μm. The pitch is typically no greater than 600 μm and preferably less than 400 μm. The width of the microstructured (e.g. groove) may be different between the upper surface and the lower surface, particularly when the barrier ribs thus formed are tapered. The width is generally at least 10 μm, and typically at least 50 μm. Further, the width is typically no greater than 100 μm and typically less than 80 μm.

The thickness of a representative shape-imparting layer is at least 5 μm, typically at least 10 μm, and more typically at least 50 μm. Further, the thickness of the shape-imparting layer is no greater than 1,000 μm, typically less than 800 μm and more typically less than 700 μm. When the thickness of the shape-imparting layer is below 5 μm, the desired rib height typically cannot be obtained. When the thickness of the shape-imparting layer is greater than 1,000 μm, warp and reduction of dimensional accuracy of the mold can result due to excessive shrinkage.

The mold includes a non-molding (e.g. non-rib) region 160 typically comprised of the same material as the microstructured molding region. The non-molding (e.g. non-rib) regions are provided for various reasons. With reference to FIG. 2, depicting a roll of flexible molds, non-rib regions 142 are provided between microstructured molding surface regions 180a, 180b, and 180c to separate the microstructured molding surface into portions suitably sized individual plasma display panels. The non-rib regions 143 can also be provided at peripheral locations parallel to the length of the roll to provide regions to grip the flexible molds to facilitate handling. For example (e.g. automated) machinery may grip the molds in order to stretch the molds to align the microstructures as described in U.S. Pat. No. 6,616,887 and Published Application No. 2007/0018363. The non-rib regions can also serve as locations to bond a frame to maintain alignment of a stretched rib as described in Published Application No. 2007/0018348.

The non-molding (e.g. non-rib) regions are typically provided at the periphery of the mold on at least two opposing sides. In the case of quadrilateral shaped molds, opposing sides are generally parallel to each other. The entire periphery of the microstructured surface of a (e.g. sheet) mold may be bounded by non-molding regions.

The dimensions of the non-molding region can vary. For flexible molds suitably sized for the manufacture of a 30 to 60 inch plasma display back panel, the width of the non-molding regions between microstructured molding regions of adjacent discrete molds, i.e. d₁ of FIG. 2, is typically at least 10 mm to 100 mm. The non-molding regions parallel to the length of the roll, i.e. d₂ of FIG. 2, typically have a width of at least 5 mm to 50 mm.

It has been found that a flexible mold having non-molding regions can be further improved by surface modifying the non-molding regions on at least two opposing sides. In general, the surface modification of the non-molding regions provides a non-molding region having a reduced contact area. The reduced contact area can reduce the adhesion of the non-molding regions of the mold with the substrate during molding, thereby reducing positional error of the molded barrier ribs.

During use of the mold, a coating of paste of uniform thickness is typically provided on an electrode patterned substrate, such as described in WO 03/032353. The width of this coating typically does not extend beyond the peripheral (e.g. groove 130a) recesses of the microstructured molding surface. When the mold contacts the uniform coating of paste, the planar surfaces of peripheral planar portions 145 contact the substrate. However, the uppermost surface of the surface modified non-molding regions 160 either do not contact the substrate at all, by virtue of having a substantially reduced thickness or have substantially reduced contact with the substrate by virtue of other physical or chemical surface modifications.

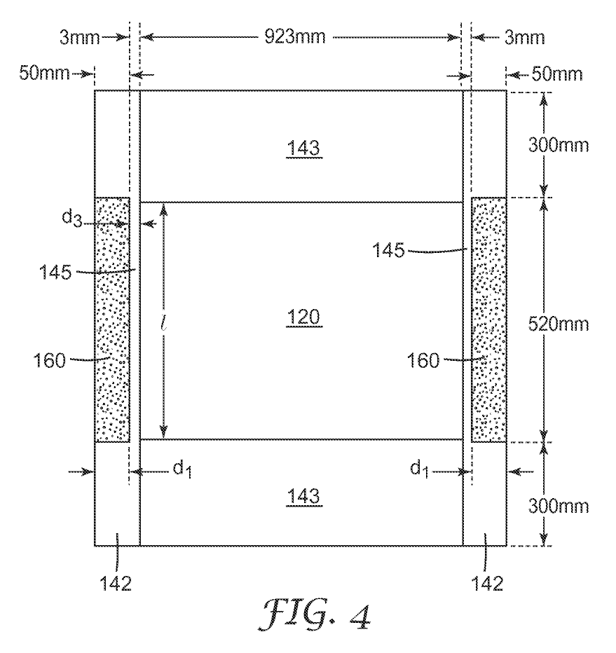

With reference to FIGS. 1-4, planar portion 145, directly adjacent to the outermost peripheral (e.g. groove 130a) recess of the microstructured surface is unmodified so as to not hinder the formation of the microstructure formed from groove 130a. As shown in FIG. 4, this unmodified planar portion 145 typically extends the length (“l”) of the microstructured molding surface. With reference to FIG. 3, the unmodified planar portion has a width, d₃, at least about 10 to 20 times the width of the groove. More typically, the width, d₃, of the unmodified planar portion is at least 30 times to 50 times the width of the groove. In some embodiments, the unmodified planar portion 145 may have a width 100× to 500× the width of the outermost peripheral groove.

The unmodified planar portion 145 typically has a relatively small contact area in comparison to the surface modified non-molding region 160, such as depicted in FIG. 4. The unmodified planar portion 145 may constitute about 1% to 10% (e.g. 4% to 6%) of the total area of the unmodified planar portion in combination with the modified non-molding regions.

Various approaches can be employed to physically and/or chemically modify the non-molding regions.

In one aspect, the contact area of the non-molding region can be reduced by reducing the thickness of at least portions of the non-molding region adjacent the unmodified peripheral planar portions 145. The thickness of the physically modified non-molding region is typically reduced by at least 10%, 20%, 30% or 40% relative to the adjacent peripheral planar portions 135a. In some embodiments, 100% of the physically modified non-molding region adjacent unmodified region 135a is removed such that only support 110 remains in such physically modified regions.

In another aspect, at least portions of the non-molding regions may comprise a roughened surface. The non-rib regions may be sanded or abraded by other means thereby providing a surface roughness Ra of at least 1 micron. Typically, the surface roughness is no greater than about 10 microns.

Another way of physically modifying at portion of the non-molding region is to microstructure the non-molding region. Such microstructures are generally substantially smaller than the microstructures (e.g. grooves) of the microstructured surface of the mold. For examples the microstructures of the non-rib regions may range in size from about 1 to about 10 percent of the size of the microstructures of the microstructured surface of the mold.

Alternatively, the non-molding regions can be chemically modified by coating the surface a fluorinated material or a silicone material as known in the art.

Any one or combination of the physical and/or chemical modifications described herein can be utilized.

The surface modifications can be incorporated into the flexible mold by first making the flexible mold having the non-molding regions by methods known in the art and then surface modifying a portion of the non-molding regions on at least two opposing sides of the flexible mold. Alternatively however, the physical modifications can be incorporated into the transfer mold from which the flexible mold is formed and/or be incorporated into the master mold from which the transfer mold is formed. The preparation of a transfer mold from a master mold is known such as described in U.S. Patent Publication 2005/0206034. Further, the preparation of a master mold is also known such as described in U.S. Publication No. 2006/0225463.

The preparation of a flexible mold from a transfer mold is known such as described in U.S. Publication No. 2006-0231728. In an embodied method of manufacture of a flexible mold, a polymerizable resin composition is provided at least in the recesses of the microstructured surface of a (e.g. polymeric) transfer mold having, a corresponding inverse microstructured surface pattern as the flexible mold,. This can be accomplished with known customary coating means such as a knife coater or a bar coater. A support comprising a flexible polymeric film is stacked onto the polymerizable resin filled mold such that the resin contacts the support. While stacked in this manner, the polymerizable resin composition is cured. Photocuring is typically preferred. For this embodiment, it is preferred that the support as well as the polymerizable composition are sufficiently optically transparent such that rays of light irradiated for curing can pass through the support. Once cured, the flexible mold, having the support film integrally bonded to the shape-imparting layer formed from the cured polymerizable resin, is separated from the transfer mold.

Suitable photocurable polymerizable resin compositions for preparation of the shape-imparting layer of the flexible mold are also known such as described in U.S. Publication No. 2006/0231728.

Prior to preparation of the flexible mold, the transfer mold and support film are typically conditioned in a humidity and temperature controlled chamber (e.g. 22° C./55% relative humidity) to minimize any dimensional changes thereof. It is also desirable to maintain a constant humidity and temperature during the method of making barrier ribs from the flexible mold. Such conditioning is further described in WO 2004/010452; WO 2004/043664 and JP Application No. 2004-108999, filed Apr. 1, 2004; incorporated herein by reference.

Although the support may optionally comprise the same material as the shape-imparting layer, for example by coating the polymerizable composition onto the transfer mold in an amount in excess of the amount needed to only fill the recesses, the support is typically a preformed polymeric film. The thickness of the polymeric support film is typically at least 0.025 millimeters, and more typically at least 0.075 millimeters. Further the thickness of the polymeric support film is generally less than 0.5 millimeters and typically less than 0.175 millimeters. The tensile strength of the polymeric support film is generally at least about 5 kg/mm² and typically at least about 10 kg/mm². The polymeric support film typically has a glass transition temperature (Tg) of about 60° C. to about 200° C. Various materials can be used for the support of the flexible mold including cellulose acetate butyrate, cellulose acetate propionate, polyether sulfone, polymethyl methacrylate, polyurethane, polyester, and polyvinyl chloride. The surface of the support may be treated to promote adhesion to the polymerizable resin composition. Examples of suitable polyethylene terephthalate based materials include photograde polyethylene terephthalate and polyethylene terephthalate (PET) having a surface that is formed according to the method described in U.S. Pat. No. 4,340,276; incorporated herein by reference.

Methods of making microstructured articles from flexible molds are also known such as described for example in U.S. Published Application No. 2006/0235107. In one embodied method, a flat transparent (e.g. glass) substrate, having an (e.g. striped) electrode pattern is provided. The flexible mold described herein is positioned for example by use of a sensor such as a charge coupled device camera, such that the barrier pattern of the mold is aligned with the patterned substrate. A curable ceramic paste can be provided between the substrate and the shape-imparting layer of the flexible mold in a variety of ways. The curable material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. For example a (e.g. rubber) roller may be employed to engage the flexible mold with the barrier rib precursor. The rib precursor spreads between the glass substrate and the shape-imparting surface of the mold filling the groove portions of the mold. In other words, the rib precursor sequentially replaces air of the groove portions. Subsequently, the rib precursor is cured. The rib precursor is preferably cured by radiation exposure to (e.g. UV) light rays through the transparent substrate and/or through the mold. The flexible mold is removed while the resulting cured ribs remain bonded to the substrate.

The curable rib precursor (also referred to as “slurry” or “paste”) comprises at least three components. The first component is a glass- or ceramic-forming particulate material (e.g. powder). The powder will ultimately be fused or sintered by firing to form microstructures. The second component is a curable organic binder capable of being shaped and subsequently hardened by curing, heating or cooling. The binder allows the slurry to be shaped into rigid or semi-rigid “green state” microstructures. The binder typically volatilizes during debinding and firing and thus may also be referred to as a “fugitive binder”. The third component is a diluent. The diluent typically promotes release from the mold after hardening of the binder material. Alternatively or in additional thereto, the diluent may promote fast and substantially complete burn out of the binder during debinding before firing the ceramic material of the microstructures. The diluent preferably remains a liquid after the binder is hardened so that the diluent phase-separates from the binder material during hardening. The rib precursor preferably has a viscosity of less than 20,000 cps and more preferably less than 5,000 cps to uniformly fill all the microstructured groove portions of the flexible mold without entrapping air. The rib precursor composition preferably has a viscosity of between about 20 to 600 Pa-S at a shear rate of 0.1/sec and between 1 to 20 Pa-S at a shear rate of 100/sec. Suitable ceramic paste compositions are known such as described in U.S. Publication No. 2006/0235107.

In some embodiment, the photoinitiator of the polymerizable composition of the shape-imparting layer is different that the photoinitiator of the ceramic paste as described in U.S. Publication No. 2006/0113713.

Various other aspects that may be utilized in the invention described herein are known in the art including, but not limited to each of the following patents that are incorporated herein by reference: U.S. Pat. Nos. 6,247,986; 6,537,645; 6,352,763; 6,843,952, 6,306,948; 6,761,607; 6,821,178; PCT Publications WO 99/60446; WO 2004/062870; WO 2004/007166; WO 03/032354; WO 03/032353; WO 2004/010452; WO2004/064104; WO 2004/043664; WO2005/042427; WO2005/019934; WO2005/021260; and WO2005/013308; WO2005/052974; WO2005/068148; WO2005/097449; U.S. Publication Nos. 2006/0043647; 2006/0043638; 2006/0043634 and U.S. PublicationNos. 2007/0018363; 2006/0231728; 2007/0018348; 2006/0235107; 2007/0071948.

The present invention is illustrated by the following non-limiting examples. The ingredients employed in the examples are described in Table 1 as follows:

TABLE 1

| | | Trade Designation | |
|---|---|---|---|
| Chemical Name | Vendor Name | Abbreviation | Function |
| γ-methacryloxypropyl | Nippon Unicar | A174 | Primer for glass |
| trimethoxysilane | Co., Ltd. | | substrate |
| Polyester based urethane | Daicel-UCB Co., Ltd | EB 8402 | Oligomer |
| acrylate | | | |
| Dimethacrylate of | Kyoeisya | Epoxyester | Oligomer |
| bisphenol A diglycidyl | Chemical Co., | 3000M | |
| ether | Ltd. | | |
| Phenoxyethylacrylate | Osaka Organic | POA | Mold Diluent |
| | Chemical | | |
| | Industry, Ltd. | | |
| Triethylene glycol | Wako Pure | TEGDMA | Curable binder |
| dimethacrylate | Chemical | | |
| | Industries, Ltd. | | |
| 1,3-butane-diol | Wako Pure | 1,3-butane-diol | Paste Diluent |
| | Chemical | (“1,3-BD”) | |
| | Industries, Ltd. | | |
| Phosphate ester | 3M Co. | POCAII | Stablizer |
| 2-hydroxy-2-methyl-1- | CIBA Specialty | Darocure 1173 | Photoinitiator |
| phenylpropane-1-one, | Chemical | | |
| 1-[4-(2-hydroxyethoxy)- | CIBA Specialty | Irgacure 2959 | Photoinitiator |
| phenyl]-2-hydroxy-2- | Chemical | | |
| methyl-1-propane-1-one | | | |
| Lead borosilicate glass | Asahi Glass Co., | RFW-030 | Filler |
| powder | Ltd. | | |

### Preparation of Microstructured Flexible Molds

A microstructured mold was prepared with a polymerizable composition containing 80 parts by weight (pbw) of Ebecryl 270 acrylated urethane oligomer and 20 pbw of POA and 1 pbw Darocure-1173 photoinitiator. The polymerizable composition was mixed at ambient temperature and coated onto the surface of a transfer mold having a lattice pattern (which is the same as the eventual barrier ribs). The dimensions of the microstructured molding surface and non-molding regions of the mold are shown in FIG. 4. The microstructured surface of the mold had two sets of parallel intersecting grooves, each set having a 300 μm rib pitch, 200 μm rib height, and 80 μm rib top width. The thickness of the (e.g. non-rib) non-molding region was 250 μm. Polyester film (PET) (made by Teijin Dupont, trade name Tetron Film) 250 microns thick, was laminated on top of the coated surface and cured through the PET with 3,000 mj/cm² of ultraviolet light using a fluorescent lamp having a peak wavelength at 352 nm (manufactured by Mitsubishi Electric Osram LTD). The plastic film with cured resin was detached from the positive tool to obtain a 500 micron thick, flexible, transparent mold having a negative pattern.

### Preparation of Photocurable Precusor Paste

21.0 gms of Epoxyester 3000M, 9.0 gms of TEGDMA, 30.0 gms of 1,3-butandiol, 3.0 gms of POCA II, 0.3 gms Irgacure 819, and 180 gms of glass frit RFW-030 were mixed with Conditioning Mixer AR-250 (manufactured by THINKY Corporation) at ambient temperature until homogeneous.

### Measurement of Surface Roughness

Five samples 0.15 mm by 0.15 mm in area were viewed through a 20× lense of a laser microscope VK9500 manufactured by KEYENCE Corp. The surface roughness was measured at a depth interval of 0.2 microns and the Average Arithmatic Mean Deviation of the Profile (Ra) and the standard deviation were calculated according to JIS B 0601-1994.

### Measurement of Microstructure Positional Error

A point was selected on the mold and the corresponding point on the cured barrier rib pattern was located. The distance from this point to a reference mark was measured by use of a Coordination Measurement Machine (manufactured by Sokkia Fine Systems Co., Ltd.). Five measurements were made in both the long (1000 mm) and short (500 mm) dimension of the mold and cured barrier rib pattern. The maximum difference between the measured value of the point on the mold and the corresponding point on the cured rib was calculated.

### EXAMPLE 1

Material was removed from the periphery of two opposing non-molding regions by cutting with a razor blade and removing portions of the cured non-molding region. With reference to FIG. 4, the removed portions had a width of 5 mm, a length of 520 mm, and a depth of 250 microns.

A glass substrate was primed by coating the surface with a 1 to 2% solution of A-174 diluted with IPA and dried at ambient conditions for 15 minutes.

The photocurable precursor paste was coated onto a primed glass substrate and the mold was laminated to the coated glass by use of a roller. The curable paste was cured with 0.16 mW/cm² light by irradiating through the flexible mold for 30 seconds with a fluorescent lamp having a peak wavelength at 400-500 nm (Philips). The mold was then separated leaving the cured barrier ribs bonded to the glass substrate. The maximum microstructure positional error of the cured barrier ribs was determined to be 18 ppm.

### EXAMPLE 2

With reference to FIG. 4, portions of the non-molding regions of two opposing sides of two separate samples were roughened with #180 sandpaper to a surface roughness of 17.95 micron Ra with a sigma of 1.95 microns. This mold was used to make barrier rib microstructures in the same manner as Example 1. The maximum microstructure positional error of the cured barrier ribs was determined to be 34 ppm.

### COMPARATIVE EXAMPLE A

A mold was prepared according to the method described above except that the non-molding regions were not physically modified. The mold was used to mold barrier rib microstructures in the same manner as Example 1. The maximum microstructure positional error of the barrier ribs was determined to be 115 ppm.

What is claimed is:

1. A mold suitable for making barrier ribs on a substrate comprising:
a microstructured surface suitable for molding barrier ribs wherein the microstructured surface comprises grooves separated by planar portions having a surface in a common plane and non-molding regions adjacent peripheral planar portions on at least two opposing sides wherein the non-molding regions comprise at least one surface modification that reduces the contact area of the non-molding regions.

2. The mold of claim 1 wherein the peripheral planar portions have a width at least 10 to 20 times the width of an adjacent groove.

3. The mold of claim 1 wherein the non-molding regions have a height that has been reduced by 10% to 100% relative to the peripheral planar portions.

4. The mold of claim 1 wherein the non-molding regions comprise a roughened surface.

5. The mold of claim 4 wherein the surface has a roughness of at least about 1 micron.

6. The mold of claim 1 wherein the non-molding regions comprise a microstructured surface having substantially smaller microstructures than the barrier ribs.

7. The mold of claim 1 wherein the mold is light transmissive.

8. The mold of claim 1 wherein the mold is flexible.

9. The mold of claim 1 wherein the microstructured surface of the mold comprises a cured polymeric material disposed on a polymeric support film.

10. A method of making barrier ribs on a substrate comprising:
providing a mold comprising a microstructured surface suitable for molding barrier ribs wherein the microstructured surface comprises grooves separated by planar portions having a surface in a common plane and peripheral non-molding regions adjacent peripheral planar portions on at least two opposing sides wherein the non-molding regions comprise at least one surface modification that reduces the contact of the non-molding regions with the substrate;
providing a rib precursor material between the microstructured surface of the mold and the substrate thereby filling the grooves and peripheral non-molding regions;
curing the rib precursor material; and
removing the mold thereby providing cured barrier ribs on a substrate.

11. The method of claim 10 wherein the mold is removed in a direction substantially parallel to the physically modified non-molding regions.

12. The method of claim 10 wherein the barrier ribs comprise a maximum positional error of less than 50 ppm.

13. The method of claim 10 wherein the substrate is an inorganic material and the method comprises sintering the cured barrier ribs on the substrate.

14. The method of claim 10 wherein the mold, substrate, or combination thereof, is light transmissible and the rib precursor material is photocured through the substrate, through the mold, or a combination thereof.

15. A method of making a microstructured mold comprising:
providing a mold comprising a microstructured surface suitable for molding barrier ribs wherein the microstructured surface comprises grooves separated by planar portions having a surface in a common plane and peripheral non-molding regions adjacent peripheral planar portions wherein the non-molding regions comprise at least one surface modification that reduces the contact area of the non-molding regions; and
reducing the contact area of portions of the non-molding regions.

16. The method of claim 15 wherein the surface of the non-molding regions has been reduced by sanding or reducing the thickness of at least portions of the non-molding region.

17. A method of making a microstructured mold suitable for making barrier ribs comprising:
providing a transfer mold or master mold for making a transfer mold having a microstructured surface suitable for molding barrier ribs wherein the microstructured surface comprises grooves defined by planar portions having a surface in a common plane and peripheral non-molding regions adjacent peripheral planar portions on at least two opposing sides;
physically modifying at least portions of the non-molding regions of the transfer mold, master tool, or a combination thereof to reduce the contact area of the non-molding regions;
optionally employing the master tool to make a transfer mold; and
employing the transfer mold to make a microstructured mold.

18. The method of claim 17 wherein the transfer mold has a microstructured surface that is substantially the same as the barrier ribs; and the microstructured mold is prepared by providing a polymerizable resin in at least recesses of the microstructured surface of the transfer mold;
stacking a polymeric film support onto the transfer mold;
curing the polymerizable resin; and
removing the cured polymerized resin composition together with the support form the transfer mold.

19. A mold suitable for making microstructures on a substrate comprising:
comprising a microstructured surface suitable for molding microstructures wherein the microstructured surface comprises recesses separated by planar portions having a surface in a common plane and peripheral non-molding regions adjacent planar portions on at least two opposing sides wherein the non-molding regions comprise at least one surface modification that reduces the contact area of the non-molding regions.

20. A method of making microstructures comprising:
providing the mold of claim 19;
providing a curable material between the microstructured surface of the mold and the substrate thereby filling the recesses of the mold;
curing the curable material; and
removing the mold thereby providing cured microstructures on a substrate.
